(19) United States
(12) Patent Application Publication
(10) Pub. No.: US 2012/0262613 A1
(43) Pub. Date: Oct. 18, 2012

(54) SOLID-STATE IMAGING APPARATUS

(75) Inventors: Shoji Kono, Hachioji-shi (JP); Takashi Matsuda, Yokohama-shi (JP)

(73) Assignee: CANON KABUSHIKI KAISHA, Tokyo (JP)

(21) Appl. No.: 13/430,957

(22) Filed: Mar. 27, 2012

(30) Foreign Application Priority Data
Apr. 18, 2011 (JP) 2011-092085

(51) Int. Cl. H04N 5/335

(52) U.S. Cl. 348/300; 348/302; 348/E05.091

(57) ABSTRACT

A solid-state imaging apparatus includes: pixels arranged in a two-dimensional matrix; a signal line connected to the pixels; and the mechanical shutter for shielding the pixels. The pixel includes: a photoelectric conversion unit generating a signal by photoelectric conversion; a reset unit resetting a signal of the photoelectric conversion unit; and a selecting unit for switching between a selecting state and a non-selecting state. The reset unit terminates the reset operation at different timing for each row of the pixels, thereby starting the charge accumulation period in the photoelectric conversion unit. The mechanical shutter shields the photoelectric conversion unit, thereby terminating the charge accumulation period.

### BACKGROUND OF THE INVENTION

1. Filed of the Invention

The present invention relates to a solid-state imaging apparatus.

2. Description of the Related Art

In recent years, a digital camera including a mechanical shutter has been used for moving image photographing. Further, there is a need for a function to take a still image during moving image photographing. An example for implementing the function is to suspend the moving image photographing in the middle, return the mechanical shutter to an initial photographing state, or a closed state, and then start still image photographing. This method is disadvantageous in that it takes time to transfer from the moving image photographing to the still image photographing. In order to solve the problem, Japanese Patent Application Laid-Open No. 2006-166417 describes a configuration that starts charge accumulation of a photoelectric conversion unit by a pixel reset operation of a solid-state imaging apparatus and termination thereof, and then terminates the charge accumulation by operating a mechanical shutter to shield the photoelectric conversion unit. Further, Japanese Patent Application Laid-Open No. 2006-166417 describes that highly accurate control of a shutter charge accumulation period is achieved by synchronizing a reset operation of the solid-state imaging apparatus to the running characteristics of the mechanical shutter. In recent years, the number of pixels in digital cameras has increased. The increased number of pixels necessitates faster readout of a signal. Accordingly, Japanese Patent Application Laid-Open No. 2007-202035 describes a solid-state imaging apparatus with an improved reading speed by simultaneously reading signals from a plurality of rows.

Desirable reset operation has not been sufficiently studied in the configuration that simultaneously reads signals from pixel rows and a charge accumulation period in a photoelectric conversion unit is started by termination of a reset operation of the photoelectric conversion unit and the charge accumulation period is terminated by a mechanical shutter. Conventionally, a readout operation of a signal from pixels and a pixel reset operation are performed by a vertical scanning circuit. Elements having the same function in a pixel row basis or in a plurality of pixel rows basis are controlled to operate by the same control signal. For instance, in a configuration of simultaneously reading signals from a plurality of pixel rows, pixel selecting units included in the plurality of pixel rows are simultaneously operated, and, also in a reset operation, reset units included in the plurality of pixel rows are simultaneously operated.

According to studies conducted by inventors of the present invention, in the case of simultaneously performing a reset operation of the pixel rows and then terminating a charge accumulation period by a mechanical shutter, charge accumulation periods of the respective pixel rows vary from each other. It has been found that this variation causes a problem that should be solved for acquiring a high quality image. For instance, in a solid-state imaging apparatus of a APS-C type with 12 million pixels (about 3000 pixel rows), the difference of charge accumulation periods between pixel rows using a mechanical shutter with a screen speed of 4 ms and a charge accumulation period (shutter speed) of 1/8000 second is about 1.1% at the maximum, which may cause a striped noise. If a gain to a pixel signal is increased for improvement in sensitivity, the noise may be significant.

It is an object of the present invention to provide a solid-state imaging apparatus that terminates a charge accumulation period by a mechanical shutter and can acquire a high quality image.

### SUMMARY OF THE INVENTION

According to one aspect of the present invention, a solid-state imaging apparatus comprises: a plurality of pixels being arranged in a matrix; and a plurality of signal lines each receiving a signal outputted from the plurality of pixels, wherein each of the pixels includes a photoelectric conversion unit; a reset unit for resetting a signal generated in the photoelectric conversion unit; and a selecting unit for switching between a selecting state and a non-selecting state, and wherein the solid-state imaging apparatus starts a charge accumulation period of the photoelectric conversion unit by terminating a reset operation of the reset unit in different timing for each of the rows of the pixels, and terminates the charge accumulation period of the photoelectric conversion unit by shading the photoelectric conversion unit from a light with a mechanical shutter, and the selecting unit performs a selecting operation such that periods of the selecting state for a plurality of rows of the pixels overlap with each other.

Further features of the present invention will become apparent from the following description of exemplary embodiments with reference to the attached drawings.

### BRIEF DESCRIPTION OF THE DRAWINGS

FIG. 1 is a conceptual diagram of an imaging system.

FIG. 2 is a diagram illustrating an operation of a mechanical shutter on an imaging surface of a solid-state imaging apparatus.

FIG. 3 is a plan view of the solid-state imaging apparatus.

FIG. 4 is a circuit diagram of the solid-state imaging apparatus.

FIG. 5 is a timing chart of a circuit in FIG. 4.

FIG. 6 is a diagram illustrating a charge accumulation period of each row.

FIG. 7 is a central longitudinal sectional diagram in a side view schematically illustrating a configuration of an imaging apparatus.

FIG. 8 is circuit diagram of the solid-state imaging apparatus.

FIG. 9 is a diagram illustrating a charge accumulation period of each row in the solid-state imaging apparatus.

FIG. 10 is a diagram illustrating the charge accumulation period of each row in the solid-state imaging apparatus in FIG. 8.

FIG. 11 is a diagram illustrating the charge accumulation period of each row in the solid-state imaging apparatus.

### DESCRIPTION OF THE EMBODIMENTS

Preferred embodiments of the present invention will now be described in detail in accordance with the accompanying drawings.

### First Embodiment

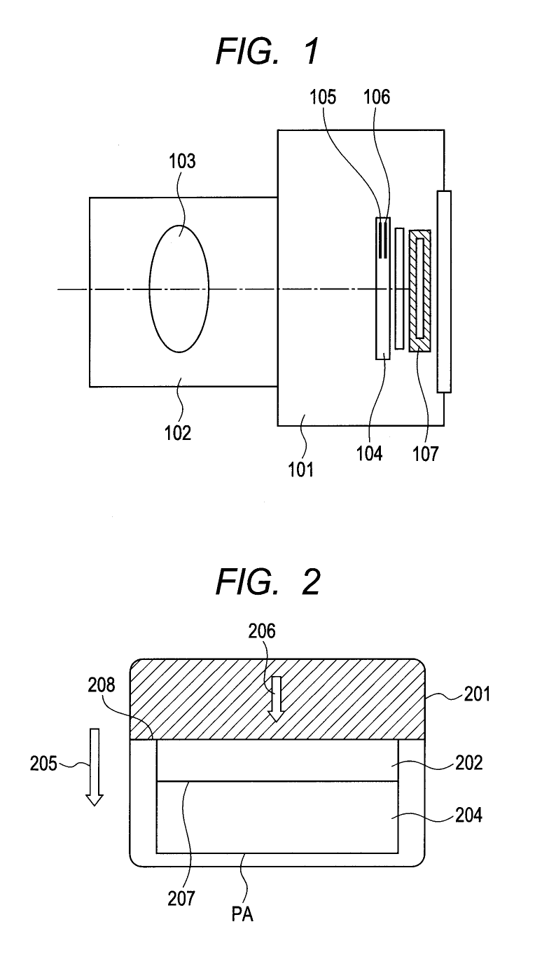

FIG. 1 is a conceptual diagram of an entire imaging system including solid-state imaging apparatus according to a first embodiment of the present invention. A camera main body 101 is illustrated. Light passing through a lens unit 102 is focused by an optically focusing system 103 on a solid-state imaging apparatus 107. A mechanical shutter 104 may be switched between two states: a full aperture state where light into the solid-state imaging apparatus 107 is incident and a shield state where the solid-state imaging apparatus 107 is shielded from the incident light. For instance, a specific configuration of the mechanical shutter 104 includes a front curtain 105 for opening an optical path to the solid-state imaging apparatus 107, and a rear curtain 106 for shutting the optical path. Such a configuration is sometimes referred to as a focal-plane shutter. There are two cases, which are a case where the front curtain 105 sets the start of a charge accumulation period of the photoelectric conversion unit in the solid-state imaging apparatus 107, and a case where an electric reset operation of the solid-state imaging apparatus 107 sets the start of a charge accumulation period without operating the front curtain 105. These cases may be switchable. Instead of providing the front curtain 105, the charge accumulation period may be started on termination of an electric reset operation of the solid-state imaging apparatus 107.

FIG. 2 is a diagram illustrating an operation of a mechanical shutter on an imaging surface of the solid-state imaging apparatus. FIG. 2 illustrates an example in which the charge accumulation period is started by terminating the electric reset operation and terminated by shielding by the mechanical shutter. The solid-state imaging apparatus has an imaging region PA. In the imaging region PA, pixels are arranged in a matrix. As shown, a rear curtain 201 of the mechanical shutter runs from the upper part of the diagram to the distal position 208 to partially cover the imaging region PA, thereby shielding light. That is, the rear curtain 201 runs in the direction indicated by an arrow 206 along the direction from the upper to lower surfaces of the casing. A pixel region 202 is a part for a charge accumulation period in the imaging region. That is, the pixel region 202 is in a state after termination of the electric reset operation and before shielding by the rear curtain 201. The pixel region 202 includes one or more pixel rows according to the set length of charge accumulation period. A pixel region 204 is a part before a charge accumulation period in the imaging region. Pixels in the pixel region 204 may be in a state where photoelectric conversion units are maintained in an electrically reset state. Instead, these pixels may be in a state where light continues to be incident on the photoelectric conversion units and the pixels are waiting for an electric reset operation. The electric reset operation is performed in the photoelectric conversion units immediately before the start of the charge accumulation period. A boundary 207 is between the pixel region 202 in the charge accumulation period and the pixel region 204 before the charge accumulation period. It can be considered that the boundary indicates a boundary of completion of the electric reset operation of the photoelectric conversion unit from the upper to lower parts of the diagram. That is, the slit-shaped pixel region 202 that is between the boundary 207 and the distal end 208 of the rear curtain 201 is subjected to charge accumulation. The electric reset operation is sequentially performed. A time from passing of the boundary 207 from the upper to lower parts of the diagram and to entering into the shield state by the rear curtain 201 is the charge accumulation period. That is, the charge accumulation operation of the pixel is started by terminating the electric reset operation of the photoelectric conversion unit and terminated by shielding the photoelectric conversion unit by the mechanical shutter.

Here, in the case where the rear curtain 201 runs at an inconstant speed, such as in the case of being driven by a spring force, the line indicating the running of the rear curtain 201 represents a curve. The pixel reset operation may be terminated based on the curve. After the rear curtain 201 has run to the bottom of the imaging region PA to cover the entire imaging region PA, readout scanning is performed in the direction indicated by an arrow 205 identical to the running direction of the rear curtain 201 (the direction indicated by the arrow 206). For instance, the readout scanning is sequentially performed from the pixel row at the upper part of the diagram to the pixel row at the lower part of the pixel row of the diagram to perform the pixel readout operation on each row. The signal readout operation here indicates an operation of reading a signal from each pixel to a corresponding vertical signal line.

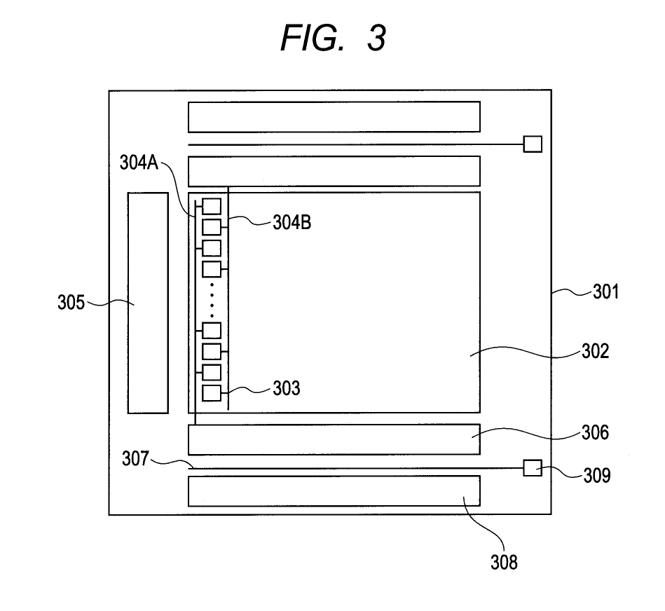

FIG. 3 illustrates a plan view of the solid-state imaging apparatus. For instance, a solid-state imaging apparatus 301 includes a semiconductor substrate, and elements, such as transistors and diodes, arranged thereon. All elements, which will be described later, may be arranged on the identical semiconductor substrate. Instead, a part of the elements may be arranged on another semiconductor substrate. A pixel array 302 corresponds to the pixel array PA in FIG. 2. Pixels 303 are arranged in a two-dimensional matrix, and generate a signal by photoelectric conversion. Each pixel 303 includes at least a photoelectric conversion unit. The pixel 303 further includes a reset unit that resets the signal in the photoelectric conversion unit, and a selecting unit that selectively outputs the signal of the pixel to the vertical signal lines 304A and 304B. The pixel column is configured by a column of pixels 303. FIG. 3 illustrates one pixel column. The entire imaging region is configured by arranging a plurality of the pixel columns. A pixel row is a group of pixels arranged in the direction orthogonal to the arrangement direction of the pixels configuring the pixel column. Vertical signal lines 304A and 304B are connected to the pixels 303. Signals of the pixels included in one pixel column are output to the vertical signal lines 304A and 304B. Here, signals of odd-numbered pixel rows included in one pixel column are output to the vertical signal line 304A. Signals of even-numbered pixel rows on the identical pixel column are output to the vertical signal line 304B. Each pixel column is provided with the vertical signal lines 304A and 304B. A vertical scanning unit 305 has a configuration capable of sequentially supplying a drive pulse to a prescribed pixel row. For instance, the vertical scanning unit 305 may be configured by a shift register or a decoder. The vertical scanning unit 305 configures a controller that controls operations of a reset unit and a selecting unit which will be described later. A column circuit unit 306 is provided for each pixel column or each plurality of pixel columns. The column circuit unit 306 processes signals read by the vertical signal lines 304A and 304B in parallel at the substantially same time. For instance, the column circuit unit 306 may include an amplifying circuit, a CDS circuit and an AD converting circuit. A horizontal signal line 307 sequentially receives a signal after being processed by the column circuit unit 306 and output therefrom. A horizontal scanning unit 308 has a configuration capable of sequentially supplies a drive pulse to a prescribed pixel column. For instance, the horizontal scanning unit 308 may be configured by a shift register or a decoder. An output unit 309 amplifies or buffers the signals transmitted in the horizontal signal line. The signals are read from an output pad, not illustrated, to the outside of the solid-state imaging apparatus. As illustrated in the diagram, the column circuit unit 306, the horizontal signal line 307, the horizontal scanning unit 308 and the output unit 309 are arranged below the pixel array. As with the lower configuration, the units can also be arranged upwardly. According to the configuration in FIG. 3, the vertical signal lines are arranged for each pixel column. Accordingly, the signals of the pixels included in the identical pixel column can be read into the vertical signal lines in parallel. Here, the signals of the odd-numbered pixel rows and the signals of the even-numbered pixel rows can be read in parallel.

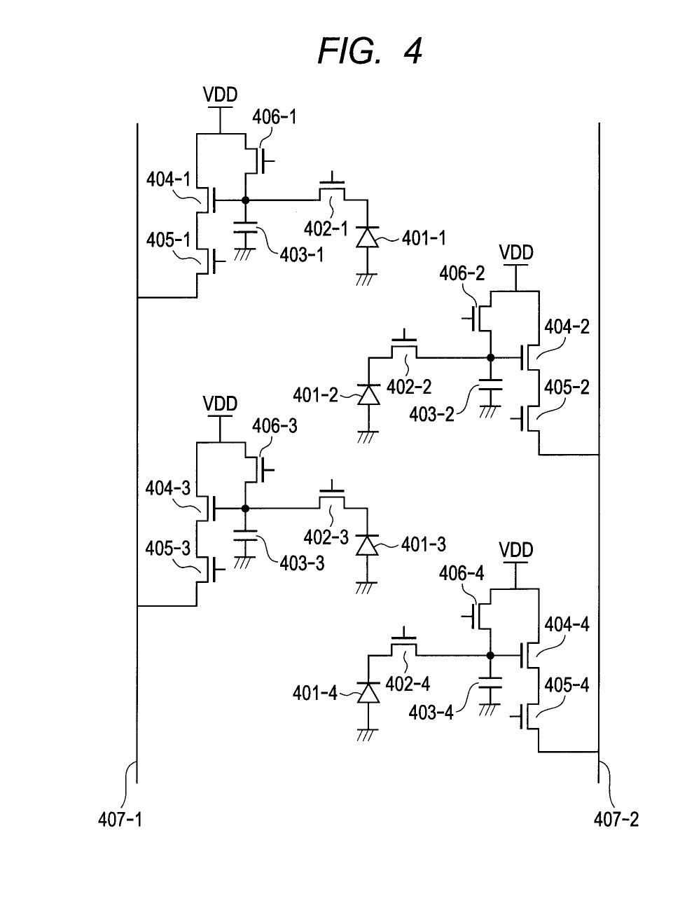

FIG. 4 illustrates an equivalent circuit diagram of the pixels 303. Here, four adjacent pixels included in the identical pixel column are illustrated. Photoelectric conversion units 401-1 to 401-4 generate signals by photoelectric conversion. For instance, these units can be configured by photodiodes having a p-n junction. Transfer units 402-1 to 402-4 transfer signal charges generated in the photoelectric conversion units 401-1 to 401-4 to the floating diffusions 403-1 to 403-4, respectively. The transfer units 402-1 to 402-4 can be configured by, for instance, MOS transistors. Although explicitly illustrated in this diagram, the capacitances of the floating diffusions 403-1 to 403-4 may have any capacitance such as of a parasitic capacitance and a p-n junction capacitance resulting from a semiconductor region constituting the floating diffusion along with a semiconductor region therearound. Pixel amplifying units 404-1 to 404-4 amplify the signals from the photoelectric conversion units 401-1 to 401-4, respectively. The pixel amplifying units 404-1 to 404-4 may adopt, for instance, MOS transistors. The gates of the MOS transistors are electrically connected to the floating diffusions 403-1 to 403-4, respectively. The pixel amplifying units 404-1 to 404-4 may adopt various circuit configurations. For instance, a source follower circuit may be adopted. In this case, the gate of the MOS transistor in the source follower circuit serves as an input node. The source serves as an output node. The transfer units 402-1 to 402-4 transfer the signals of the photoelectric conversion units 401-1 to 401-4 to the pixel amplifying units 404-1 to 404-4, respectively. Selecting units 405-1 to 405-4 control electric connections between the output nodes of the pixel amplifying units 404-1 to 404-4 and the vertical signal lines 407-1 and 407-2 such that amplified signals of the pixel amplifying units 404-1 to 404-4 are output to the vertical signal lines 407-1 and 407-2 for each pixel row. The selecting units 405-1 to 405-4 perform switching between a selecting state for outputting the signals of the photoelectric conversion units 401-1 to 401-4 to the vertical signal lines 407-1 and 407-2, and a non-selecting state of not outputting the signals of the photoelectric conversion units 401-1 to 401-4 to the vertical signal lines 407-1 and 407-2. MOS transistors may be adopted as the selecting units 405-1 to 405-4. Pixel reset units 406-1 to 406-4 and the transfer units 402-1 to 402-4 are conducted at the same time, thereby enabling the signals of the photoelectric conversion units 401-1 to 401-4 to be reset. For instance, MOS transistors may be adopted as the pixel reset units 406-1 to 406-4. The reset units for resetting the signals of the photoelectric conversion units 401-1 to 401-4 are configured by the pixel reset units 406-1 to 406-4 and the transfer units 402-1 to 402-4. The reset units reset the signals of the photoelectric conversion units 401-1 to 401-4. Instead, reset units electrically connected to the photoelectric conversion units 401-1 to 401-4 without intervention of the transfer units 402-1 to 402-4 may separately be provided.

This diagram illustrates adjacent four pixel rows. The four pixel rows are electrically connected to the two vertical signal lines 407-1 and 407-2 in an alternate manner. To improve the signal readout speed from the pixels to the vertical signal lines 407-1 and 407-2, this configuration can perform control such that the signals of the adjacent two pixel rows are read in parallel. More specifically, a drive pulse is supplied from the controller so as to conduct the selecting units 405-1 and 405-2 at the same time while the signals of the photoelectric conversion unit 401-1 and 401-2 are transferred to the input nodes of the pixel amplifying units 404-1 and 404-2. Subsequently, in the state where the selecting units 405-1 and 405-2 are caused to be nonconducting and the signals of the photoelectric conversion units 401-3 and 401-4 are transferred to the input nodes of the pixel amplifying units 404-3 and 404-4, the selecting units 405-3 and 405-4 are controlled to be conducted at the same time. The control is performed according mainly to the drive pulse from the vertical scanning unit 305. The vertical scanning unit 305 thus configures a part of the controller. A timing generator may be included in the controller.

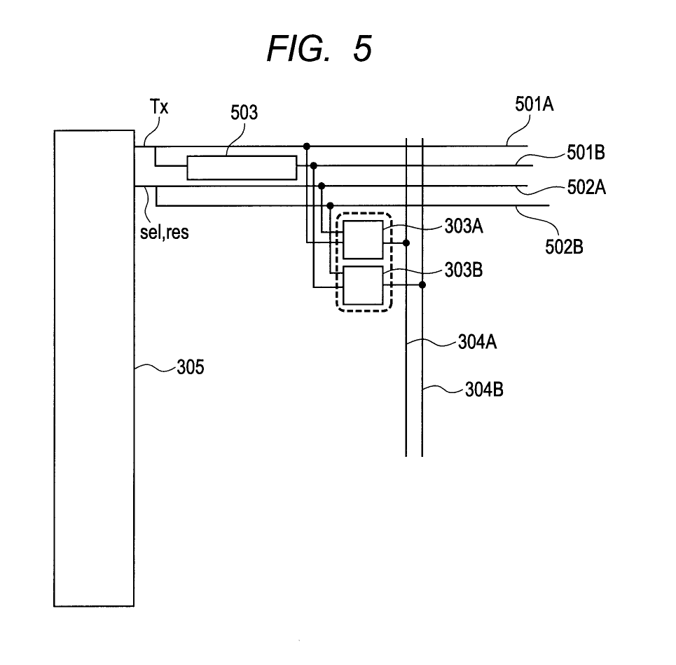

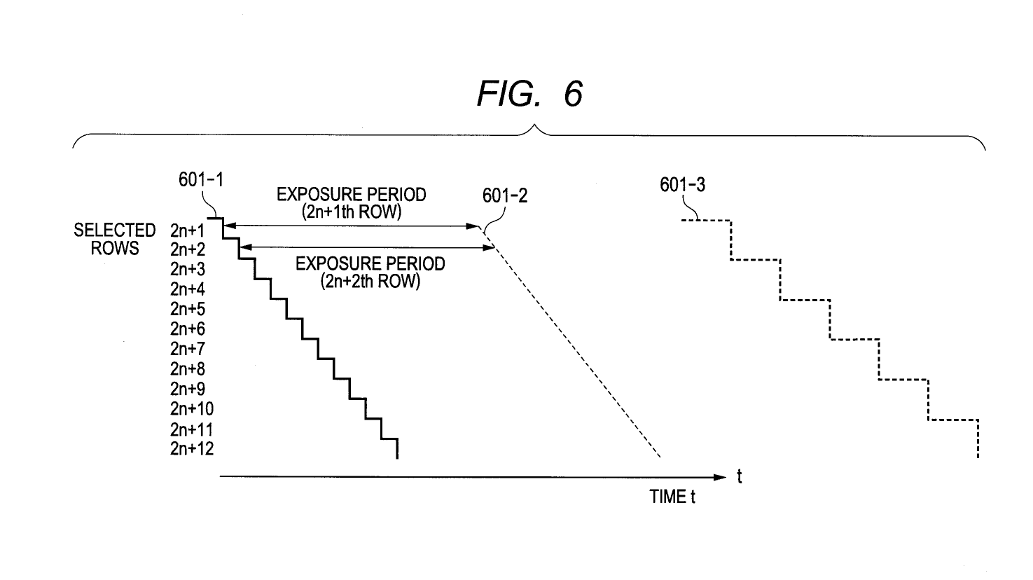

FIG. 5 is a conceptual diagram of the vertical scanning unit 305 and the drive pulse line. Elements having functions analogous to those in FIG. 3 are assigned with analogous symbols. The detailed description thereof is omitted. Pixels 303A and 303B are supplied with the drive pulses Tx, sel and res from the vertical scanning unit 305. The pixel 303A is on the (2n+1)-th row. The pixel 303B is on the (2n+2)-th row.

Transfer pulse supplying lines 501A and 501B supply the drive pulse Tx to the transfer units 402-1 to 402-4 of the pixels 303. The line 501A supplies the drive pulse Tx to the transfer unit of the pixel 303A on the (2n+1)-th row. The line 501B supplies the drive pulse Tx to the transfer unit of the pixel 303B on the (2n+2)-th row. Drive pulse supplying lines 502A and 502B supply the drive pulse res to the pixel reset units 406-1 to 406-4 of the pixels 303, and supply the drive pulse sel to the selecting units 405-1 to 405-4. The drive pulse supplying line 502A supplies the pixel reset unit of the pixel 303A on the (2n+1)-th row with the drive pulse res, and supplies the selecting unit with the drive pulse sel. The drive pulse supplying line 502B supplies the pixel reset unit of the pixel 303B on the (2n+2)-th row with the drive pulse res, and supplies the selecting unit with the drive pulse sel. Here, the line is represented by a single line. In actuality, the pixel reset unit and the selecting unit are provided with respective lines. More specifically, a common line is assigned for supplying the drive pulse res to the pixel reset units on the (2n+1)-th and (2n+2)-th rows. A common line is assigned for supplying the drive pulse sel to the selecting units on the (2n+1)-th (2n+2)-th rows. In particular, a pulse adjusting circuit 503 is a delay circuit. The pulse adjusting circuit 503 is provided for supplying each pixel row with transfer pulse Tx output from the vertical scanning unit 305 in a manner with timings shifted between the (2n+1)-th and (2n+2)-th rows. The delay amount of the pulse adjusting circuit 503 is determined according to a difference in length of the signal accumulation period in the rows.

In FIG. 5, the drive pulse is supplied according to which the periods where the selecting unit of the pixel 303A on the (2n+1)-th row and the selecting unit of the pixel 303B on the (2n+2)-th row are in the selecting state overlap with each other such that the signals of the pixel rows can be read to the vertical signal lines 304A and 304B in parallel. Here, no electric element, such as a switch, is provided between the vertical scanning unit 305 and the drive pulse supplying lines 502A and 502B, and the parasitic capacitance and parasitic resistance of pixels up to the pixel on the identical pixel column are substantially identical. In other words, the drive pulse supplying lines 502A and 502B are same electric nodes with respect to the vertical scanning unit 305.

FIG. 6 is a diagram illustrating charge accumulation periods on the respective pixel rows in the solid-state imaging apparatus. The abscissa indicates elapsed times. The ordinate indicates selected pixel rows. A reset pulse 601-1 resets the photoelectric conversion units 401-1 to 401-4 on the respective pixel rows. When the reset pulse 601-1 at a high level is supplied, the photoelectric conversion units 401-1 to 401-4 are reset. When the reset pulse 601-1 at a low level is supplied, the state comes to a state where the reset is terminated. In the circuit diagram of FIG. 4, the reset pulse 601-1 represents the high level pulse for conducting both the transfer units 402-1 to 402-4 and the pixel reset units 406-1 to 406-4. The timing when the reset operation is terminated defines the timing of starting the charge accumulation period on each pixel. The drive pulse is supplied so as to sequentially terminate the reset state on each pixel row. A position 601-2 indicates the position on which the mechanical shutter 104 runs to start shielding of the photoelectric conversion units 401-1 to 401-4 of the respective pixels. The shutter runs so as to sequentially shield each pixel row. The position 601-1 indicates the start timing of the charge accumulation period. The position 601-2 indicates the terminating timing of the charge accumulation period. The reset units 402-1 to 402-4 and 406-1 to 406-4 terminate the reset operation at different timings for each row of the pixels 303, thereby starting the charge accumulation periods in the photoelectric conversion units 401-1 to 401-4. The mechanical shutter 104 shields the photoelectric conversion units 401-1 to 401-4, thereby terminating the charge accumulation periods. According to the operation as illustrated by the positions 601-1 and 601-2, the charge accumulation period on each row becomes substantially constant. At the timing 601-3, the signals of the pixel rows are read to the vertical signal lines 407-1 and 407-2. Here, the drive pulse sel is supplied such that the periods in which the selecting units 405-1 and 405-2 on the two pixel rows (a plurality of rows) are in the selecting state overlap with each other. That is, the selecting units 405-1 and 405-2 perform selection such that the periods in the selecting state on the two rows of the pixels 303 overlap with each other.

As illustrated in FIG. 4, the vertical signal lines 407-1 and 407-2 are provided on each pixel column, thereby allowing the signals of the pixels on the pixel rows to be read even though the selecting units 405-1 and 405-2 on the pixel rows are in the selecting state at the same time. Here, the control is performed such that the periods in which the selecting units 405-1 and 405-2 on the two pixel rows becomes in the selecting state overlap with each other. However, the number of pixel rows where the periods in the selecting state overlap with each other is according to the number of the vertical signal lines 407-1 and 407-2 provided in a manner corresponding to the pixel columns. Thus, the reset operation is terminated for each pixel row, and the periods in which the selecting units 405-1 and 405-2 are in the selecting state overlap with each other for each pixel row. Accordingly, the charge accumulation period on each pixel row becomes substantially constant, the striped noise can be reduced, and the speed of the signal readout can be improved.

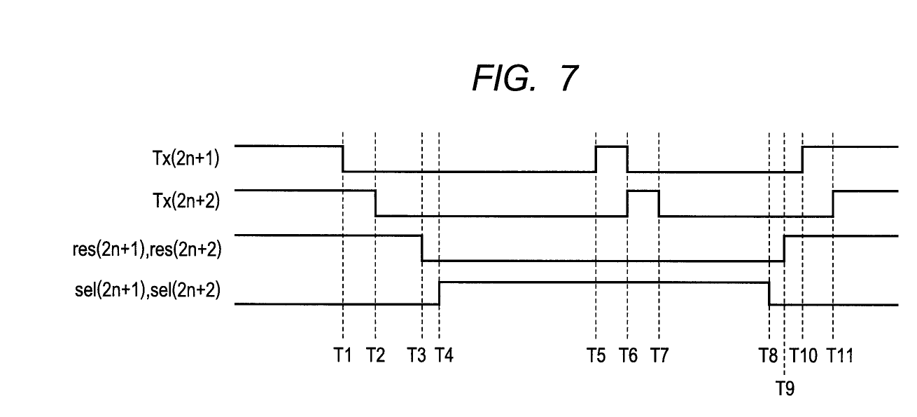

FIG. 7 illustrates an example of the drive pulse, and illustrates adjacent two pixel rows. A pulse Tx is supplied to the transfer units 402-1 to 402-4 of the pixels 303. A pulse res is supplied to the pixel reset units 406-1 to 406-4 of the pixels 303. A pulse sel is supplied to the selecting units 405-1 to 405-4 of the pixels 303. The state is active at the high level. Before T1, the pulses Tx and res are at the high level, and the photoelectric conversion units 401-1 to 401-4 are in the reset state. At T1, the pulse Tx (2n+1) of the pixels on the (2n+1)-th row transitions to the low level. This transitions starts the charge accumulation period of the pixels 303 on the (2n+1)-th row. At this time, the pulse Tx (2n+2) of the pixels on the (2n+2)-th row remains at the high level. At T2, the pulse Tx (2n+2) of the pixels on the (2n+2)-th row transitions to the low level. This transition starts the charge accumulation period of the pixels on the (2n+2)-th row. At T3, the pulses res (2n+1) and res (2n+2) of the pixels on the (2n+1)-th and (2n+2)-th rows transition to the low level. This transition floats the potentials of the floating diffusions 403-1 and 403-2. At T4, the pulses sel(2n+1) and sel(2n+2) of the pixels on the (2n+1)-th and (2n+2)-th rows transition to the high level. This transition outputs the signals of the pixels on the (2n+1)-th row and (2n+2)-th rows to the corresponding vertical signal lines 407-1 and 407-2, respectively. At this time, the output signals are signals in the state where the floating diffusions 403-1 and 403-2 are reset. These signals are so-called noise signals. This operation is required for a CDS operation, but is not required if the CDS operation is not performed. At T5, the pulse Tx (2n+1) of the pixels on the (2n+1)-th row transitions from the low level to the high level. According to this operation, the charges of the photoelectric conversion units 401-1 of the pixels on the (2n+1)-th row are transferred to the respective floating diffusions 403-1.

At T6, the pulse Tx (2n+2) of the pixels on the (2n+2)-th row transitions from the low level to the high level. According to this operation, the charges of the photoelectric conversion units 401-2 of the pixels on the (2n+2)-th row are transferred to the respective floating diffusions 403-2. At this time, the pulse Tx (2n+1) of the pixels on the on the (2n+1)-th row simultaneously transitions from the high level to the low level. However, the timing is not necessarily same as the timing T6. At T7, the pulse Tx (2n+2) of the pixels on the (2n+2)-th row transitions from the high level to the low level. At T8, the pulses sel(2n+1) and sel(2n+2) of the pixels on the (2n+1)-th and (2n+2)-th rows transition from the low level to the high level. In the period from T4 to T8, the signals are output to the vertical signal lines 407-1 and 407-2. Accordingly, at any timing in this period, the signal is held by a subsequent reading circuit. At T9, the pulses res (2n+1) and res (2n+2) of the pixels on the (2n+1)-th and (2n+2)-th rows transition from the low level to the high level. At T10, the pulse Tx (2n+1) of the pixels on the (2n+1)-th row transitions from the low level to the high level. This transition resets the photoelectric conversion unit 401-1 of the pixels on the (2n+1)-th row, and starts the charge accumulation period in the next frame. At T11, the pulse Tx (2n+2) of the pixels on the (2n+2)-th row transitions from the low level to the high level. This operation resets the photoelectric conversion unit 401-2 of the pixels on the (2n+2)-th row, and starts the charge accumulation period in the next frame.

The pixel reset units 406-1 and 406-2 reset the input sections of the pixel amplifying units 404-1 and 404-2 while the transfer units 402-1 and 402-2 are in the transfer state, thereby resetting the signals of the photoelectric conversion units 401-1 and 401-2. The transfer units 402-1 and 402-2 terminate the transfer state at a different timing for each row of the pixels 303 by the pulses Tx (2n+1) and Tx (2n+2), when terminating the reset.

### Second Embodiment

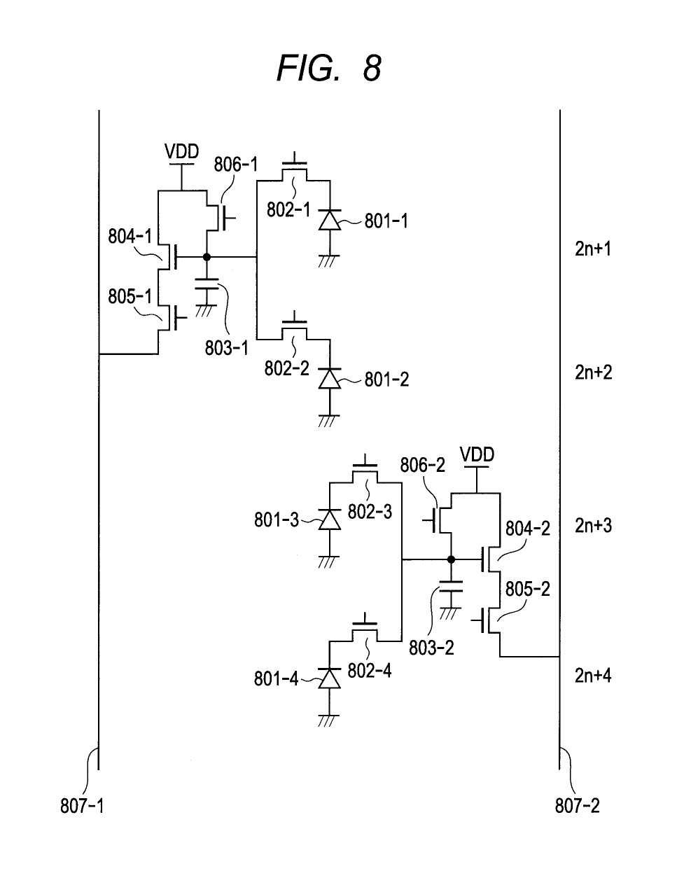

A second embodiment of the present invention is an example in which photoelectric conversion units share one pixel amplifying unit. Parts of the configuration may be analogous to those of the first embodiment. FIG. 8 exemplifies the circuit diagram of the pixels 303 of the second embodiment of the present invention. The transfer units 802-1 to 802-4 can separately be controlled. Accordingly, the photoelectric conversion units 801-1 to 801-4 can separately be reset.

Here, four adjacent pixels included in an identical pixel column are illustrated. The photoelectric conversion units 801-1 to 801-4 are of the pixels on the (2n+1)-th to (2n+4)-th rows, respectively. The units can be configured by, for instance, a photodiode having a p-n junction. The transfer units 802-1 to 802-4 transfer the signal charges caused in the photoelectric conversion units 801-1 to 801-4 to the floating diffusion 803-1 or 803-2. The transfer units 802-1 to 802-4 can be configured by, for instance, a MOS transistor. The floating diffusion 803-1 is common to the photoelectric conversion units 801-1 and 801-2. The floating diffusion 803-2 is common to the photoelectric conversion units 801-3 and 801-4. Although explicitly illustrated in this diagram, the capacitances of the floating diffusions 803-1 and 803-2 may have any capacitance such as of a parasitic capacitance or by a p-n junction capacitance resulting from a semiconductor region constituting the floating diffusion along with a semiconductor region therearound. The pixel amplifying unit 804-1 amplifies the signal caused in one of the photoelectric conversion units 801-1 and 801-2. The pixel amplifying unit 804-2 amplifies the signal caused in one of the photoelectric conversion units 801-3 and 801-4. MOS transistors may be adopted to the pixel amplifying units 804-1 and 804-2. The gates of the MOS transistors are electrically connected to the floating diffusions 803-1 and 803-2. Various circuit configurations can be adopted as the pixel amplifying units 804-1 and 804-2. For instance, a source follower circuit can be used. In this case, the gate of the MOS transistor in the source follower circuit becomes an input node, and the source becomes an output node. A selecting unit 805-1 controls the electric connection between the output node of the pixel amplifying unit 804-1 and the vertical signal line 807-1 such that the signal amplified by the pixel amplifying unit 804-1 is output to the vertical signal line 807-1. A selecting unit 805-2 controls the electric connection between the output node of the pixel amplifying unit 804-2 and the vertical signal line 807-2 such that the signal amplified by the pixel amplifying unit 804-2 is output to the vertical signal line 807-2. For instance, MOS transistors may be adopted as the selecting units 805-1 and 805-2. The signals of the photoelectric conversion units 801-1 to 801-4 can be reset by simultaneously conducting pixel reset units 806-1 and 806-2 and the transfer units 802-1 to 802-4. For instance, MOS transistors may be adopted as the pixel reset units 806-1 and 806-2. The reset units for resetting the signals of the photoelectric conversion units 801-1 to 801-4 are configured by the pixel reset units 806-1 and 806-2 and the transfer units 802-1 to 802-4. Instead, reset units electrically connected to the photoelectric conversion units 801-1 to 801-4 without intervention of the transfer units 802-1 to 802-4 may separately be provided. The pixel amplifying unit 804-1 and the selecting unit 805-1 are shared by the photoelectric conversion units 801-1 and 801-2. The pixel amplifying unit 804-2 and the selecting unit 805-2 are shared by the photoelectric conversion units 801-3 and 801-4.

The reset timing of each row is according to an accuracy of a clock frequency used in the solid-state imaging apparatus. To reduce the error of about one percent on each row, having described in the problem, to 1/10 or less, a clock of about 10 MHz is suffice. Since the present master clock frequency is a several hundreds of megahertz, there is no problem. The drive pulse for the pixels has a delay difference between the input section and the terminal. However, the delay differences between back and forth and right and left are small. Accordingly, the differences do not cause a problem. On moving image photographing, means for shielding by the focal-plane shutter is not required to be used. Instead, reset termination of the photodiodes and charge transfer of the photodiodes can define the charge accumulation period. Accordingly, reset of the rows may be terminated at the same time, and the charges of the rows may be transferred at the same time.

### Third Embodiment

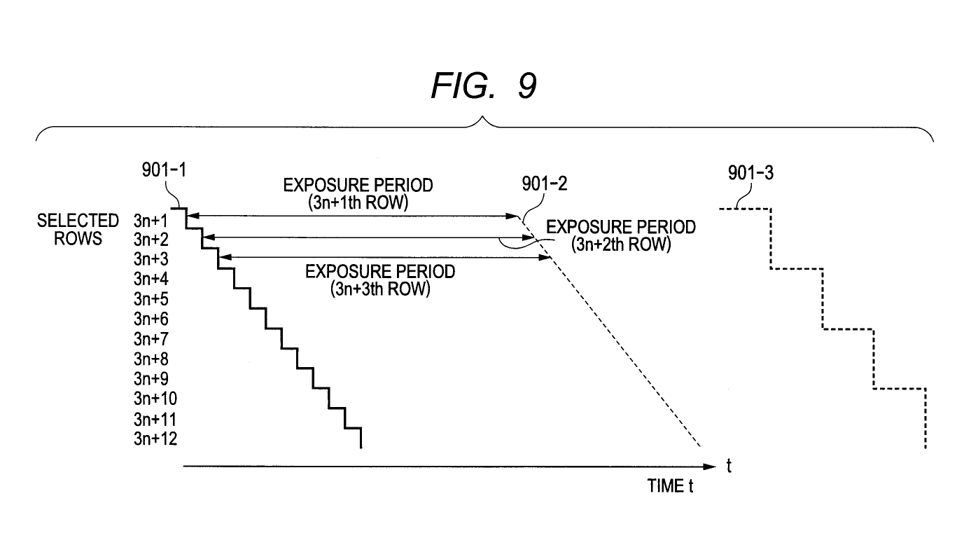

FIG. 9 is a diagram illustrating a charge accumulation period of each row in the solid-state imaging apparatus according to a third embodiment of the present invention. A reset pulse 901-1 resets the photoelectric conversion units 401-1 to 401-4 on each pixel row. When the reset pulse 901-1 at the high level is supplied, the photoelectric conversion units 401-1 to 401-4 are reset. When the reset pulse 901-1 at the low level is supplied, the reset is terminated. Referring to the circuit diagram of FIG. 4, the reset pulse 901-1 is at the high level, which conducts both the transfer units 402-1 to 402-4 and the pixel reset units 406-1 to 406-4. The timing when the reset operation is terminated defines the timing of starting the charge accumulation period in each pixel. The drive pulse is supplied so as to sequentially terminate the reset status on each pixel row. A position 901-2 indicates the position at which the mechanical shutter 104 runs to start to shield the photoelectric conversion units 401-1 to 401-4 in each pixel. The shutter runs so as to sequentially shield each pixel row. A position 901-1 indicates the start timing of the charge accumulation period. A position 901-2 indicates the terminating timing of the charge accumulation period. According to the operation as indicated by the positions 901-1 and 901-2, the charge accumulation period on each row becomes substantially constant. At a timing 901-3, the signals of the pixel rows are read to the vertical signal line. Here, the drive pulse is supplied so as to the period in which the selecting units 405-1 to 405-3 of the three pixel rows are in the selecting state overlap with each other. That is, the selecting units 405-1 to 405-3 perform selection such that the periods of the selecting state of the three pixels 303 overlap with each other.

The first and second embodiments have described the examples that have two vertical signal lines 304A and 304B for transferring signals from the pixel units for each column. The third embodiment has described the example that has three vertical signal lines for each column. The difference of the charge accumulation periods on the first and n-th rows in the case where the reset signal of starting the charge accumulation period is supplied to the n rows at the same time is (n−1) times as much as the difference of the charge accumulation periods in the case where the signal is supplied to two rows at the same time. Accordingly, the lateral stripe due to the difference in brightness of the image becomes larger. Contribution of charge accumulation period adjustment thus becomes larger. Thus, the present invention is applicable to a case having any number of vertical signal lines.

### Forth Embodiment

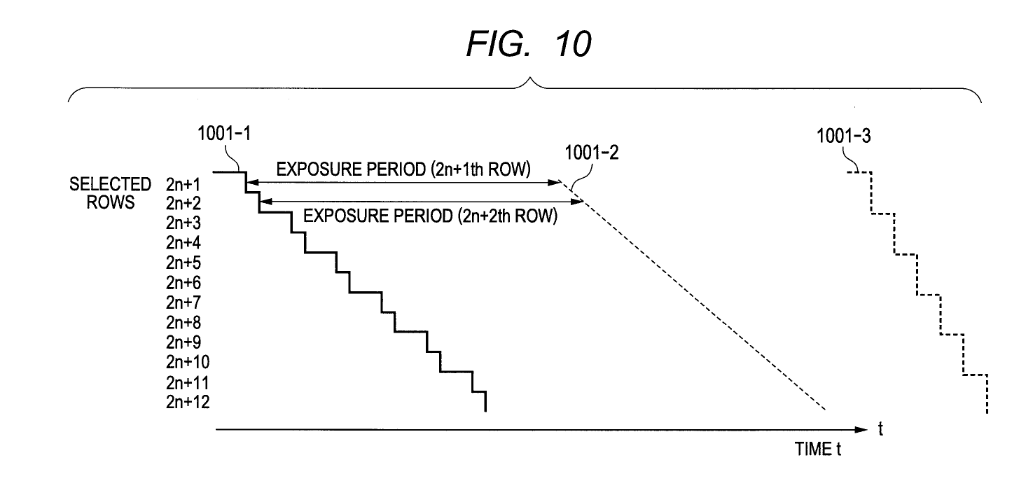

FIG. 10 is a diagram illustrating the exposure period on each row according to a fourth embodiment of the present invention. This diagram illustrates the exposure time on each row in the solid-state imaging apparatus in FIG. 8. A reset pulse 1001-1 resets the photoelectric conversion units 801-1 to 801-4 on each pixel row. When the reset pulse 1001-1 at the high level is supplied, the photoelectric conversion units 801-1 to 801-4 are reset. When the reset pulse 1001-1 at the low level is supplied, the reset is terminated. Referring to the circuit diagram in FIG. 8, the reset pulse 1001-1 is at high level, which conducts both the transfer units 802-1 to 802-4 and the pixel reset units 806-1 and 806-2. The timing when the reset operation is terminated is the timing when the charge accumulation period is started in each pixel. The drive pulse is supplied such that the reset state is sequentially terminated for each pixel row. At a position 1001-2, the mechanical shutter 104 is started to shield the photoelectric conversion units in each pixel. The shutter runs so as to sequentially shield each pixel row. The position 1001-1 indicates the start timing of the charge accumulation period. The position 1001-2 indicates the terminating timing of the charge accumulation period. The operation is performed as illustrated by the positions 1001-1 and 1001-2. Accordingly, the charge accumulation period on each row becomes substantially constant. At a timing 1001-3, the signals on the pixel row are read to the vertical signal lines 807-1 and 807-2. Here, the drive pulse is supplied such that the periods in which the selecting units on two pixel rows are in the selecting state overlap with each other.

In the case where the reset signal is supplied to each row in the first embodiment at a speed identical to the speed of scanning by the mechanical shutter 104, the difference between the exposure periods becomes the minimum. In this embodiment, the scanning speed of the reset signal on each row is not constant. However, the timings of the reset signals supplied to two rows to be processed according to the same reset signal are shifted from each other, and the row where the distal end of the mechanical shutter 104 reaches later is reset later. Accordingly, the difference between the exposure periods can be reduced. In other words, scanning is performed according to the reset signal in conformity to the running characteristics of the mechanical shutter 104. According to such control, variation in lengths of the accumulation periods is further reduced.

### Fifth Embodiment

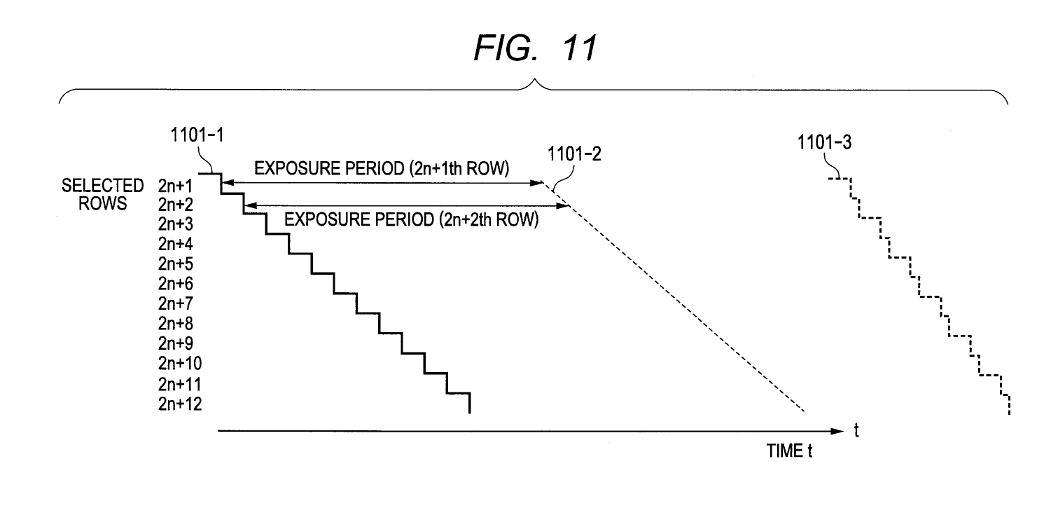

FIG. 11 is a diagram illustrating an exposure period on each row of a solid-state imaging apparatus of a fifth embodiment of the present invention. A reset pulse 1101-1 resets the photoelectric conversion units 401-1 to 401-4 of each pixel row. When the reset pulse 1101-1 at the high level is supplied, the photoelectric conversion units 401-1 to 401-4 are reset. When the reset pulse 1101-1 at the low level is supplied, the reset is terminated. The timing when the reset operation is terminated defines the timing of starting the charge accumulation period on each pixel. The drive pulse is supplied so as to sequentially terminate the reset state for each pixel row. At a position 1101-2, the mechanical shutter 104 runs to start to shield the photoelectric conversion units in each pixel. The shutter runs so as to sequentially shield each pixel row. A start timing 1101-1 of the charge accumulation period is illustrated. A terminating timing 1101-2 of the charge accumulation period is illustrated. The operation as illustrated by the timings 1101-1 and 1101-2 is thus performed. Accordingly, the charge accumulation period on each row becomes substantially constant. At a timing 1101-3, the signals on each pixel row are read to the vertical signal lines 407-1 and 407-2. Here, the drive pulse is supplied such that the periods in which the selecting units on one pixel row are in the selecting state do not overlap with each other. That is, each of the selecting units 405-1 to 405-4 sequentially selects a pixels 303 on a row by row basis. Accordingly, a plurality of rows is selected in one horizontal scanning period.

In the first, second and fourth embodiments, pixel signals included in the rows are read in two rows at a time. In the third and fifth embodiments, they are not read in two rows at a time. It is enough to read the pixel signals in two rows within one horizontal scanning period. Even in this case, as with the second embodiment, where the reset signal is supplied to each line at an inconstant speed, it is suffice that the process of reading of two rows is performed within one horizontal scanning period according to the reading timing.

Any of the embodiments only describes a specific example for implementing the present invention. The technical scope of the present invention shall not be construed in a limited manner according to the description. That is, the present invention can be implemented in various manners without departing from the technical thought or the main characteristics thereof.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-092085, filed Apr. 18, 2011, which is hereby incorporated by reference herein in its entirety.

What is claimed is:

1. A solid-state imaging apparatus comprising:
a plurality of pixels being arranged in a matrix; and
a plurality of signal lines each receiving a signal outputted from the plurality of pixels, wherein
each of the pixels includes
a photoelectric conversion unit;
a reset unit for resetting a signal generated in the photoelectric conversion unit; and
a selecting unit for switching between a selecting state and a non-selecting state and wherein
the solid-state imaging apparatus starts a charge accumulation period of the photoelectric conversion unit by terminating a reset operation of the reset unit in different timing for each of the rows of the pixels, and terminates the charge accumulation period of the photoelectric conversion unit by shading the photoelectric conversion unit from a light with a mechanical shutter, and
the selecting unit performs a selecting operation such that periods of the selecting state for a plurality of rows of the pixels overlap with each other.

2. The solid-state imaging apparatus according to claim 1, wherein
each of the columns of the pixels is provided with a plurality of the signal lines.

3. The solid-state imaging apparatus according to claim 1, wherein
the pixel further includes
an amplifying unit for amplifying the signal generated in the photoelectric conversion unit, and
a transfer unit for transferring the signal from the photoelectric conversion unit to the amplifying unit.

4. The solid-state imaging apparatus according to claim 3, wherein
the amplifying unit is shared by a plurality of the photoelectric conversion unit.

5. The solid-state imaging apparatus according to claim 3, wherein
the reset unit resets the signal in the photoelectric conversion unit by resetting an input portion of the amplifying unit during a period of a transferring state of the transfer unit, and
the transfer unit terminates the transferring state in a different timing for the rows of the pixels.

6. The solid-state imaging apparatus according to claim 1, wherein
the selecting unit performs the selecting operation such that periods of the selecting state for two rows of the pixels overlap with each other.

7. The solid-state imaging apparatus according to claim 1, wherein
the selecting unit performs the selecting operation such that periods of the selecting state for three rows of the pixels overlap with each other.

8. The solid-state imaging apparatus according to claim 1, wherein
the selecting unit performs the selecting operation one row by one row of the pixels.

9. A solid-state imaging apparatus comprising:
a plurality of pixels being arranged in a matrix; and
a plurality of signal lines each receiving a signal outputted from the plurality of pixels, wherein
each of the pixels includes
a photoelectric conversion unit;
a reset unit for resetting a signal generated in the photoelectric conversion unit; and
a selecting unit for switching between a selecting state and a non-selecting state and wherein
the solid-state imaging apparatus starts a charge accumulation period of the photoelectric conversion unit by terminating a reset operation of the reset unit in different timing for each of the rows of the pixels, and terminates the charge accumulation period of the photoelectric conversion unit by shading the photoelectric conversion unit from a light with a mechanical shutter, and
the selecting unit performs a selecting operation such that a plurality of rows of the pixels are set at a selection state, during a one horizontal scanning period.
